(19) United States
(12) Patent Application Publication
(10) Pub. No.: US 2022/0335470 A1
(43) Pub. Date: Oct. 20, 2022

(54) SYSTEMS AND METHODS FOR TARGETED CONTENT CURATION AND PLACEMENT OPTIMIZATION

(71) Applicants: Will Margiloff, New York, NY (US); Joshua Koran, Los Altos, CA (US)

(72) Inventors: Will Margiloff, New York, NY (US); Joshua Koran, Los Altos, CA (US)

(21) Appl. No.: 17/721,907

(22) Filed: Apr. 15, 2022

Related U.S. Application Data
(60) Provisional application No. 63/175,245, filed on Apr. 15, 2021.

(51) Int. Cl. G06Q 30/02

(52) U.S. Cl. CPC G06Q 30/0251

(57) ABSTRACT

The subject technology provides a targeted content curation and placement optimization system comprising a processor connected to a publication network, the publication network navigated by an online consumer seeking actionable content. An online demand side portal is accessible, via the publication network, to a content provider. An online supply side portal is accessible, via the network, to a publisher of content on the publication network. An integrated bidding exchange is communicatively coupled to the demand side portal and the supply side portal and presents user interfaces enabling receipt of bids from the content provider for placement of content by the publisher at a specified location or domain on the publication network. A survey placed at the specified location or domain facilitates selection or curation of targeted content.

### CLAIM OF PRIORITY

This patent application claims the benefit of priority, under 35 U.S.C. Section 119(e), to Margiloff et al, U.S. Provisional Patent Application Ser. No. 63/175,245, entitled “SYSTEM AND METHODS OF OPTIMIZING CONSUMER ENGAGEMENT WITH MARKETERS THROUGH ADVERTISEMENT :INVENTORY,” filed on Apr. 15, 2021 (Attorney Docket No. 4525.166PRV), which is hereby incorporated by reference herein in its entirety.

### TECHNICAL FIELD

The subject matter disclosed herein generally relates to the technical field of systems and methods for targeted content curation and placement optimization in a network-based publication environment.

### BACKGROUND

The present subject matter seeks to address technical problems existing in targeted content curation and placement optimization in a network-based publication environment. Characterizing the behavior of consumers and ensuring engagement is difficult to accomplish. In known systems, marketers bid on available inventory of ad placement space in a bid stream and blindly hope that an end consumer views the creative content placed in the available inventory When a marketer bids on a placement, they do not know how engaged the user is, i.e., if the user is interested in what they are promoting or even if they will view the advertisement at all. Similarly, for a given placement location in the inventory, publishers are typically only able to monetize a given placement one time and present only one creative content item from one marketer.

Conventional targeted content and placement systems fail to provide for multiple response or interaction layers. Here, enabling the participation of many parties or tenants in an active networked economy (for example, marketers, publishers, consumers, retailers, service providers, and so forth) can be difficult. For example, data for targeted content curation may be aggregated from different sources, but each source will likely have different methods of data protection with which to comply. Each source will also very often have different data content and configuration, and this may conflict with data configuration of other sources. This aggregation of disparate sources of protected information presents technical challenges, particularly in multi-tenant networks or environments.

In other aspects, user interfaces and data structures pertaining to the creation and presentation of targeted content, while having advanced in recent years, have not been optimized for use in a cross number of verticals and also for the management of more complicated subscription arrangements between providers and customers.

### BRIEF DESCRIPTION OF THE DRAWINGS

Some embodiments are illustrated by way of example and not limitation in the figures of the accompanying drawings.

FIG. 1 is a block diagram illustrating a high-level network architecture, according to an example embodiment.

FIG. 2 is a block diagram showing architectural aspects of a targeted content curation and placement optimization system, according to some example embodiments.

FIG. 3 is a block diagram illustrating a representative software architecture, which may be used in conjunction with various hardware architectures herein described.

FIG. 4 is a block diagram illustrating components of a machine, according to some example embodiments, able to read instructions from a machine-readable medium (e.g,., a machine-readable storage medium) and perform any one or more of the methodologies discussed herein.

FIGS. 5-6 depict aspects of a targeted content curation and placement optimization system, according to an example embodiment.

FIGS. 7-10 depict aspects of a survey, according to example embodiments.

FIG. 11 is a flow chart depicting operations in a method, according to an example embodiment.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiment of the inventive subject matter. It will be evident, however, to those skilled in the art that embodiments of the inventive subject matter can be practiced without these specific details. In general, well-known instruction instances, protocols, structures, and techniques have not been shown in detail. It should be understood by those with skill in the art may combine elements from various embodiments in practicing the present invention.

In some examples, the targeted content curation and placement optimization system may display actionable targeted content to users at a particular location or domain within a publication network. Responses to the actionable targeted content and other user engagement may be captured and used to derive impression data and customer data that may provide more insight into the demographics, financial situation, online browsing behavior, and or preferences of each user navigating to the particular location or domain. The impression data and customer data may be used to resolve and or enrich customer identities associated with each user. The targeted content curation and placement optimization may use the impression data, customer data, and or enriched customer identities to improve a bidding process for the placement of targeted content at a particular location or domain in the available inventory of a publisher. For example, the targeted content curation and placement optimization may generate or select targeted content for display, select or prioritize a marketer or other content provider for a particular placement, or adjust the price per placement or other parameters of a bidding process, based on one or more of the impression data, customer data, and or enriched customer identities.

In some examples, a targeted content curation and placement optimization system comprises a processor connected to a publication network, the publication network navigated by an online consumer seeking actionable content; an online demand side portal accessible, via the publication network, to a content provider; an online supply side portal accessible, via the publication network, to a publisher of content on the publication network; an integrated bidding exchange communicatively coupled to the demand side portal and the supply side portal, the bidding exchange presenting user interfaces enabling receipt of bids from the content provider for placement of content by the publisher at a specified location or domain on the publication network; the processor configured to reserve, upon receipt of a. successful bid from the content provider, the specified location or domain for placement of targeted content to the consumer; the processor further configured to present on a user interface, to the consumer, at the reserved specified location or domain, a survey soliciting feedback from the consumer on a content topic of interest to be presented to the consumer at the specified location or domain on the publication network; the processor further configured to receive consumer responses to the survey and select or curate, based on the survey responses, targeted content to be presented to the consumer at the specified location or domain on the publication network; the processor further configured to present the targeted content to the consumer at the specified location or domain on the publication network; and the processor further configured to process a transaction between the content provider and the publisher based on the presentation or a viewing of the targeted content by the consumer.

In some examples, the processor is further configured to process a transaction between the content provider and the publisher based on the presentation or a viewing of the targeted content by the consumer or a third party.

In some examples, the targeted content is a first targeted content selected or curated for a first consumer, and wherein the processor is further configured to: present on a second user interface, to a second consumer, at the reserved specified location or domain, a survey soliciting feedback from the second consumer on a second content topic of interest to be presented to the second consumer at the specified location or domain; the processor further configured to receive second consumer feedback and select or curate, based on survey responses, second targeted content to be presented to the second consumer at the specified location or domain; the processor further configured to detect a presence of the second consumer at the specified location or domain and present the second targeted content to the second consumer at the specified location or domain; and the processor further configured to process a second transaction between the content provider and the publisher based on the presentation or a viewing of the second targeted content by the second consumer.

In some examples, the processed transaction is based on one or both of the presentation of the survey or the presentation of the targeted content at the specified location or domain on the publication network,

In some examples, the processed second transaction is based on one or both of the presentation of the second survey or the presentation of the second. targeted content at the specified location or domain on the publication network.

In some examples, the processor is further configured to adapt questions in the survey dynamically based on consumer responses to the survey and reselect or re-curate the targeted content based on responses to a dynamically adapted survey.

In some examples, the processor is further configured to resolve or refine a consumer identity based on responses to the survey or an updated survey.

In general, “INVENTORY” in this context may be a term for a unit of advertising space, such as a magazine page, television airtime, direct mail message, email messages, text messages, telephone calls, etc. Advertising inventory may be advertisements a publisher has available to sell to an advertiser. In certain embodiments, advertising inventory may refer to a number of email advertisements being bought and/or sold. The terms INVENTORY and ADVERTISING INVENTORY may be used interchangeably. For email marketing campaigns, advertising inventory is typically an email message.

A “PUBLISHER” in this context may be an entity that sells advertising inventory, such as those produced by the systems and methods herein, to their email subscriber database. An advertiser may be a buyer of publisher email inventory. Examples of advertisers may include various retailers. A marketplace may allow advertisers and publishers to buy and sell advertising inventory. Marketplaces, also called exchanges or networks, may be used to sell display, video, and mobile inventory. In certain embodiments, a marketplace place be an email exchange/email marketplace. An email exchange may be a type of marketplace that facilitates buying and/or selling of inventory between advertisers and publishers. This inventory may be characterized based on customer attributes used in marketing campaigns. Therefore, an email exchange may have inventory that can be queried by each advertiser. This may increase efficiency of advertisers when purchasing inventory. A private network may be a marketplace that has more control and requirements for participation by both advertisers and publishers.

An “INDIVIDUAL RECORD” or “PROSPECT” in this context may be at least one identifier of a target. In certain embodiments, the individual record/prospect may be identified by a record identification mechanism, such as a specific email address (individual or household) that receives an email message.

An “AUDIENCE” in this context may be a group of records, which may be purchased as inventory. In certain embodiments, an audience may be a group of records selected from publisher databases of available records such as a group of consumers and their affiliated profiles. The subset of selected records may adhere to a predetermined set of criteria, such as common age range, common shopping habits, and/or similar lifestyle situation (i.e., stay-at-home mother). Advertisers generally select the predetermined set of criteria when they are making an inventory purchase.

“CARRIER SIGNAL” in this context refers to any intangible medium that is capable of storing, encoding, or carrying instructions for execution by a machine, and includes digital or analog communications signals or other intangible media to facilitate communication of such instructions. Instructions may be transmitted or received over a network using a transmission medium via a network interface device and using any one of a number of well-known transfer protocols.

“CLIENT DEVICE” in this context refers to any machine that interfaces with a communications network to obtain resources from one or more server systems or other client devices. A client device may be, but is not limited to, a mobile phone, desktop computer, laptop, portable digital assistant (PDA), smart phone, tablet, ultra-book, netbook, laptop, multi-processor system, microprocessor-based or programmable consumer electronics system, game console, set-top box, or any other communication device that a user may use to access a network.

“COMNIUNTCATIONS NETWORK” in this context refers to one or more portions of a network that may be an ad hoc network, an intranet, an extranet, a virtual private network (VPN), a local area. network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi′ network, another type of network, or a combination of two or more such networks. For example, a network or a portion of a network may include a wireless or cellular network and the coupling of the client device to the network may be a Code Division Multiple Access (CDMA) connection, a Global System for Mobile communications (GSM) connection, or another type of cellular or wireless coupling. In this example, the coupling may implement any of a variety of types of data transfer technology, such as Single Carrier Radio Transmission Technology (1×TT), Evolution-Data Optimized (EVDO) technology, General Packet Radio Service (GPRS) technology. Enhanced Data rales for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by ⁻various standard-setting organizations, other long-range protocols, or other data transfer technology,

“COMPONENT” in this context refers to a device, a physical entity, or logic having boundaries defined by function or subroutine calls, branch points, application program interfaces (APIs), or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components

A “HARDWARE COMPONENT” is a tangible unit capable of performing certain operations and may be configured or arranged in a certain physical manner. In various example embodiments, one or more computer systems (e.g., a. standalone computer system, a client computer system, or a server computer system) or one or more hardware components of a computer system (e.g., a processor or a group of processors) may be configured by software (e.g., an application or application portion) as a hardware component that operates to perform certain operations as described herein, A hardware component may also be implemented mechanically, electronically, or any suitable combination thereof. For example, a hardware component may include dedicated circuitry or logic that is permanently configured to perform certain operations. A hardware component may be a special-purpose processor, such as a Field-Programmable Gate Array (FPGA) or an Application Specific Integrated Circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors,

It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, in instances where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled.

Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

The various operations of example methods described herein may performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

“MACHINE-READABLE MEDIUM” in this context refers to a component, a device, or other tangible media able to store instructions and data temporarily or permanently, and may include, but not be limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., code) for execution by a machine, such that the instructions, when executed by one or more processors of the machine, cause the machine to perform any one or more of the methodologies described herein. Accordingly, a. “machine-readable medium” refers to a single storage apparatus or device, as well as “cloud-based” storage systems or storage networks that include multiple storage apparatus or devices. The term “machine-readable medium” excludes signals per se.

“PROCESSOR” in this context refers to any circuit virtual circuit (a physical circuit emulated by logic executing on an actual processor) that manipulates data values according to control signals (e.g., “commands”, “op codes”, “machine code”, etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency integrated Circuit (RFIC), or any combination thereof. A processor may further be a multi-core processor having two or more independent processors (sometimes referred to as “cores”) that may execute instructions contemporaneously.

With reference to FIG. I, an example embodiment of a high-level SaaS network architecture 100 is shown. A networked system 116 provides server-side functionality via a publication network 110 (e.g., the Internet or a WAN) to a client device 108. A web client 102 and a programmatic client, in the example form of an application 104, are hosted and execute on the client device 108. The networked system 116 includes an application server 122, which in turn hosts a targeted content curation and placement optimization system 106 for selecting or cu rating targeted content, and performing targeted content placement optimization, according to one embodiment. The content curation and placement optimization system 106 provides a number of functions and services to the application 104 that accesses the networked system 116. The application 104 also provides a number of interfaces described herein which facilitate, for example, the presentation of a survey to a user of the client device 108 (e.g., an online consumer seeking actionable content on the publication network 110), and responses thereto.

The client device 108 enables a user to access and interact with the networked system 116. For instance, the user provides input (e.g., touch screen input or alphanumeric input) to the client device 108, and the input is communicated to the networked system 116 via the network 110. In this instance, the networked system 116, in response to receiving the input from the user, communicates information back to the client device 108 via the network 110 to be presented to the user.

An Application Program Interface (API) server 118 and a web server 120 are coupled, and provide programmatic and web interfaces respectively, to the application server 122. The application server 122 hosts the content curation and placement optimization system 106, which includes components or applications. The application server 122 is, in turn, shown to be coupled to a database server 124 that facilitates access to information storage repositories or inventories (e.g., a database 126). In an example embodiment, the database 126 includes storage devices that store information accessed and generated by the content curation and placement optimization system 106.

Additionally, a third-party application 114, executing on a third-party server(s) 112, is shown as having programmatic access to the networked system 116 via the programmatic interface provided by the API server 118. For example, the third-party application 114, using information retrieved from the networked system 116, may support one or more features or functions on a website hosted by a third party.

Input from the user may be stored in a data cloud or other database. For example, displays, impressions, clicks, survey responses or other input received from the client device 108 may be used to generate impression data indicating the user is engaged with a survey or other targeted content displayed on the client device 108. The survey responses input by the user may be analyzed to extract customer data (e.g., a piece demographic data for the user, a piece of financial data (e.g., income, credit score, and the like) for the user, one or more interests or the user, products, or services the user has expressed an intent to purchase, brands the user favors or dislikes, and the like)

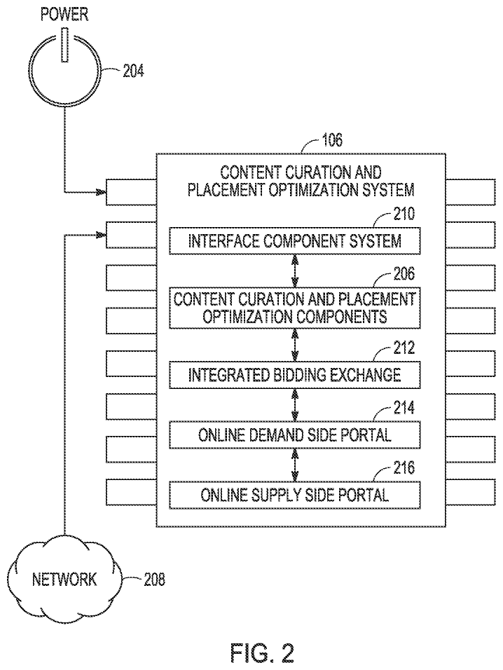

One or more components of the networked system 116 may derive the impression data and or the customer data from the user inputs and add the impression data and or customer data to a customer identity associated with the user. For example, the input from the user received by the web server 120 may be transmitted to the application server 122 and or the API server 118 for analysis. One or more components of the content curation and placement optimization system 106 and or programmatic functions of an application programing interface (API) executed by the API server 118 may generate the customer data and or impression data based on the user inputs. The customer data and or impression data may then be transmitted to the database servers 124 and or third-party servers 112 to enrich the customer identities of users engaging with the survey or other targeted content by updating the relevant customer identities based on the customer data and or impression data. As described in more detail below in FIG. 2, the enriched customer identities may enhance the networked system's 116 knowledge of each individual user that engages with the survey or other targeted content. One or more components of the application curation and placement system 106 may use the customer data, impression data, and or enriched customer identities to curate content, facilitate the exchange of ad inventory, and optimize content placement.

Turning now specifically to the applications hosted by the client device 108, the web client 102 may access the various systems -.g., content curation and placement optimization system 106) via the web interface supported by the web server 120. Similarly, the application 104 (e.g., an “app”) accesses the various services and functions provided by the content curation and placement optimization system 106 via the programmatic interface provided by the API server 118. The application 104 may be, for example, an “app” executing on the client device 108, such as an IOS™ or ANDROID™ OS application to enable a user to access and input data on the networked system 116 in an offline manner, and to perform batch-mode communications between the application 104 and the networked system 116.

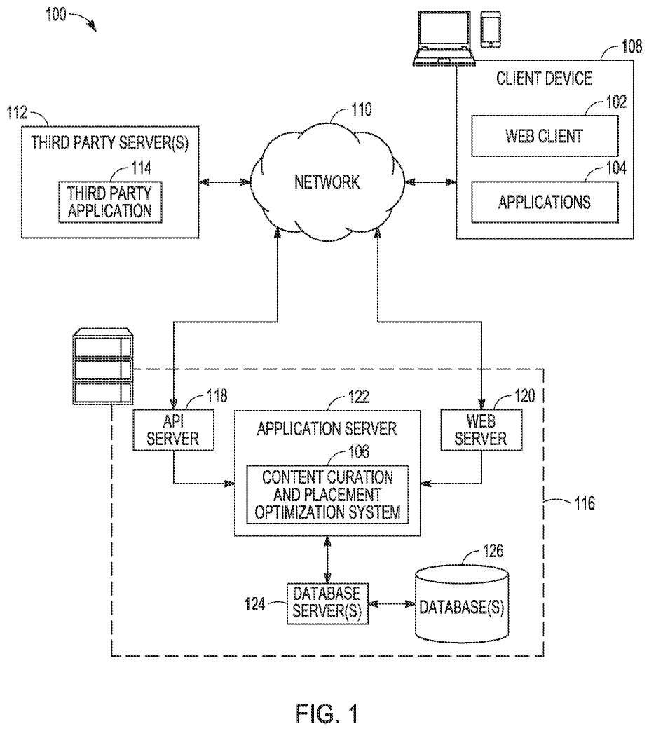

Further, while the SaaS network architecture 100 shown in FIG. 1 employs a client-server architecture, the present subject matter is not necessarily limited to such an architecture and could equally-well find application in a distributed, or peer-to-peer, architecture system, for example. The content curation and placement optimization system 106 could also be implemented as a standalone software program, which does not necessarily have networking capabilities.

FIG. 2 is a block diagram showing architectural details of a targeted content curation and placement optimization system 106, according to some example embodiments. Specifically, the content curation and placement optimization system 106 is shown to include an interface component 210 by which the content curation and placement optimization system 106 communicates (e.g., over a publication network 208) with other systems within the SaaS network architecture 100.

The interface component 210 is collectively coupled to one or more content curation and placement optimization components 206 that operate to provide specific aspects of selecting or curating targeted content, and performing targeted content placement optimization, in accordance with the methods described further below with reference to the accompanying drawings.

The targeted content curation and placement optimization system 106 includes an integrated bidding exchange 212, an online demand side portal 214 accessible to a targeted content provider, and an online supply side portal 216 accessible to a publisher of content on the publication network 208. The bidding exchange 212 is communicatively coupled to the demand side portal 214 and the supply side portal 216 to present user interfaces enabling receipt of bids from a content provider for placement of content by a publisher at a specified location or domain in available inventory on the publication network 208. The content curation and placement optimization components 206 are configured to reserve, upon receipt of a successful bid from the content provider, the specified location or domain for placement of targeted content to a user. A user may include a user as described above, for example an online consumer seeking actionable content or guidance on the publication network 208.

It should be understood that the targeted content curation and placement optimization system 106 may include one or more instances of each of the content curation and placement optimization components 206. For example, the targeted content curation and placement optimization system 106 may include multiple instances of the demand side portal 214 and multiple instances of the supply side portal 216 with each instance being operated by a different targeted content provider and different content publisher respectively. It should also be understood that the process for bidding for placement of content at a specified location or domain and the process for providing the targeted content for display may be partially or completely programmatic. For example, a. demand side API or other logic included in the online demand side portal 214 may programmatically bid on the placement of content and provide targeted content in response to providing a winning bid based on one or more parameters set by the targeted content provider and or the targeted content curation and placement optimization system 106. The demand side API may also programmatically analyze impression data, customer data, enriched customer identities, or other data presented in the demand side portal 214 to dynamically adjust bids for the placement of content in real time (e,g,, at a speed of multiple times per second or faster) according to one or more parameters set by the targeted content provider and or the targeted content curation and placement optimization system 106.

Similarly, a supply side API or other logic included in the supply side portal 216 to programmatically determine available inventory at a specified location or domain, provide the available inventory to the integrated bidding exchange 212, price the available inventory, and place targeted content within one or more reserved placements in a digital publication based on one or more parameters set by the content publisher and or the targeted content curation and placement optimization system 106. The supply side API may also programmatically analyze impression data, customer data, enriched customer identities, or other data presented in the supply side portal 216 to adjust the amount or price of available inventory or identify particular content providers that may be interested in a particular piece of available inventory according to one or more parameters set by the content publisher and or the targeted content curation and placement optimization system 106. Each function of the supply side API and or demand side API may occur automatically in real time in order to support a large volume (e.g., hundreds per second or more) of bids for the placement of content, purchases of available inventory, and displays of targeted content.

In some examples, the content curation and placement optimization components 206 are further configured to present a user interface, to the consumer, at the reserved specified location or domain. The user interface may include a survey soliciting feedback from the consumer on a content topic of interest (e.g., the consumer's interests or shopping characteristics, the desired actionable content, or other guidance) that is presented to the consumer at the specified location or domain on the publication network. Displays, impressions, clicks, survey responses, and other interactions with the survey or other targeted actionable content may be recorded as impression data by the content curation and placement optimization system 106. Survey responses input in the user interface by the consumer may also be recorded and analyzed by the content curation and placement optimization system 106 to generate customer data. The impression data and or customer data may be used by the content curation and placement optimization components 206 to select or curate, based on the survey responses, targeted content to be presented to the consumer at the specified location or domain on the publication network.

In various embodiments, the impression data and or customer data may be used to enrich a consumer identity stored in a data cloud or other database accessible over the publication network 208. The interface component 210 may provide the impression data, customer data, and or enriched customer identities to the demand side portal 214 so that a targeted content provider may understand the users interacting with the survey or other targeted content in more detail. The targeted content provider may access the bid exchange 212 through the demand side portal 214 to bid and or update a previous bid for placement of content by the publisher at a specified location or domain in available inventory. The targeted content curation and placement optimization system 106 may also generate and or select targeted content from one or more particular content publishers based on the impression data, customer data, and or enriched customer identities. The interface component 210 may also provide impression data, customer data, and or enriched customer identities to the supply side portal 216 to give the publisher of content more insight into the targeted content providers that may wish to communicate with users interacting with the survey or other targeted content, For example, the supply side portal 216 may identify content providers targeting users that have interacted with the survey based on a comparison between the preferences of the content providers and the impression data, customer data, and or enriched customer identities associated with the users. The supply side portal 216 may then send offers for placements at particular domain to an instance of the demand side portal 214 operated by one or more of the identified content providers. In some examples, the content curation and placement optimization components 206 are further configured to present the targeted content to the consumer at the specified location or domain on the publication network. In some examples, the content curation and placement optimization components 206 are further configured to process a transaction between the content provider and the publisher based on the presentation or a viewing of the targeted content by the consumer, or a third party.

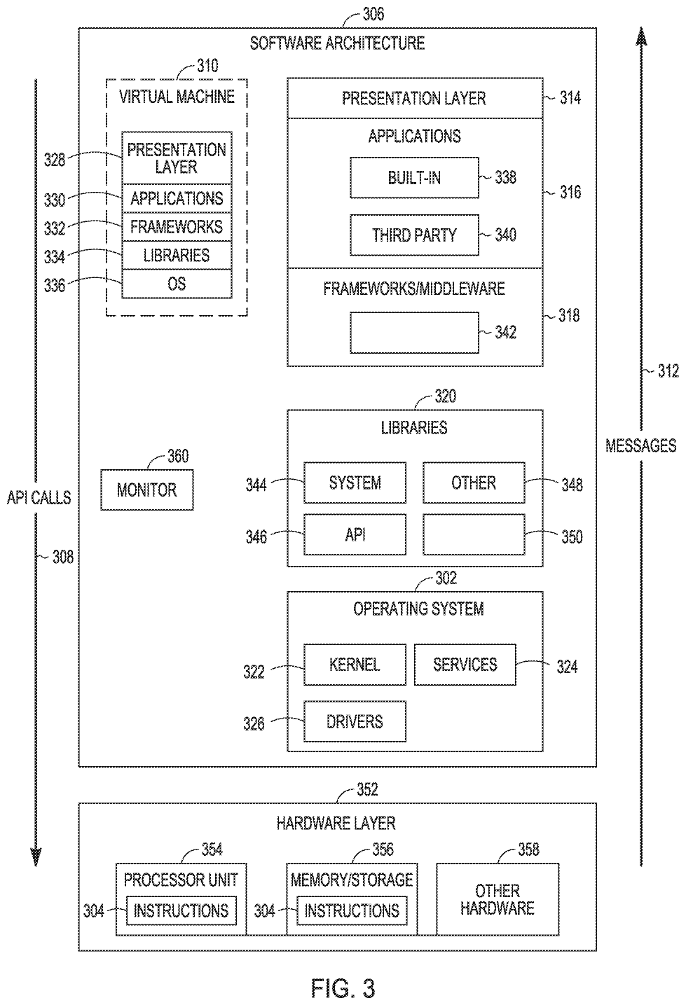

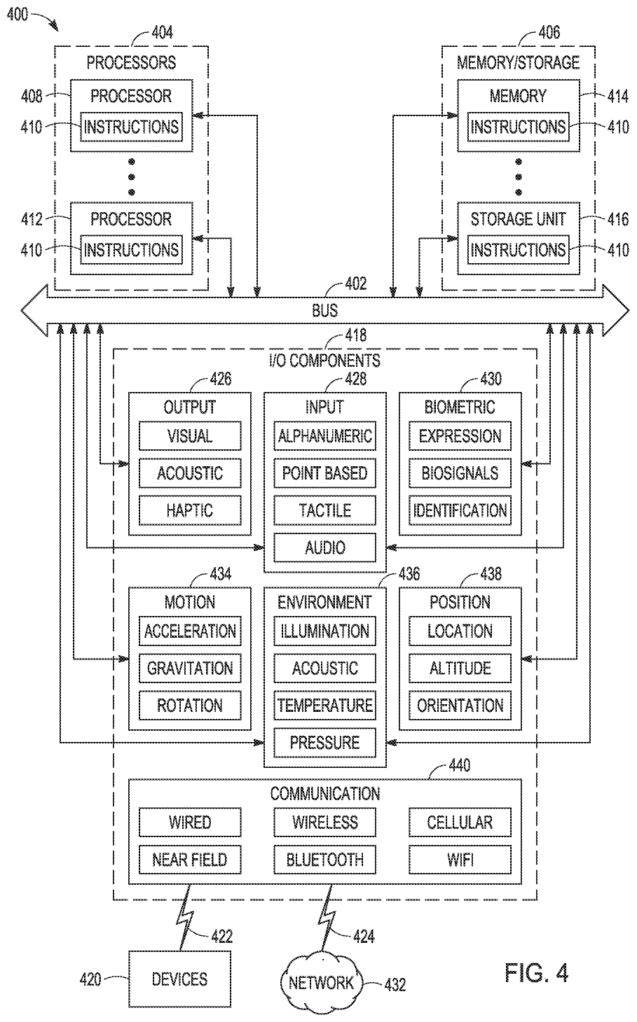

FIG. 3 is a block diagram illustrating an example software architecture 306, which may be used in conjunction with various hardware architectures herein described. FIG. 3 is a non-limiting example of a software architecture 306 and it will be appreciated that many other architectures may be implemented to facilitate the functionality described herein. The software architecture 306 may execute on hardware such as a machine 400 of FIG. 4 that includes, among other things, processors 404, memory/storage: 406, and I/O components 418. A representative hardware layer 352 is illustrated and can represent, for example, the machine 400 of HG. 4. The representative hardware layer 352 includes a processing unit 354 having associated executable instructions 304. The executable instructions 304 represent the executable instructions of the software architecture 306, including implementation of the methods, components, and so forth described herein. The hardware layer 352. also includes memory and/or storage modules as memory/storage 356, which also have the executable instructions 304. The hardware layer 352 may also comprise other hardware 358.

In the example architecture of FIG. 3, the software architecture 306 may be conceptualized as a stack of layers where each layer provides particular functionality. For example, the software architecture 306 may include layers such as an operating system 302, libraries 320, frameworks/middleware 318, applications 316, and a presentation layer 314. Operationally, the applications 316 and/or other components within the layers may invoke application programming interface (API) API calls 308 through the software stack and receive messages 312 in response to the API calls 308. The layers illustrated are representative in nature, and not all software architectures have all layers. For example, some mobile or special-purpose operating systems may not provide a frameworks/middleware 318, while others may provide such a layer. Other software architectures may include additional or different layers.

The operating system 302 may manage hardware resources and provide common services. The operating system 302 may include, for example, a kernel 322, services 324, and drivers 326. The kernel 322 may act as an abstraction layer between the hardware and the other software layers. For example, the kernel 322 may be responsible for memory management, processor management (e.g., scheduling), component management, networking, security settings, and so on. The services 324 may provide other common services for the other software layers. The drivers 326 are responsible for controlling or interfacing with the underlying hardware. For instance, the drivers 326 include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 320 provide a common infrastructure that is used by the applications 316 and/or other components and/or layers. The libraries 320 provide functionality that allows other software components to perform tasks in an easier fashion than by interfacing directly with the underlying operating system 302 functionality (e.g., kernel 322, services 324, and/or drivers 326). The libraries 320 may include system libraries 344 (e.g., C standard library) that may provide functions such as memory allocation functions, string manipulation functions, mathematical functions, and the like. In addition, the libraries 320 may include API libraries 346 such as media libraries (e.g., libraries to support presentation and manipulation of various media formats such as MPEG4, H264, MP3, AAC, AMR, IPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 320 may also include a wide variety of other libraries 348 to provide many other APIs to the applications 316 and other software components/modules.

The frameworks/middleware 318 (also sometimes referred to as middleware) provide a higher-level common infrastructure that may be used by the applications 316 and/or other software components/modules. For example, the frameworks/middleware 318 may provide various graphic user interface ((QUI) functions, high-level location services, and so forth. The frameworks/middleware 318 may provide a broad spectrum of other APIs that may be utilized by the applications 316 and/ or other software components/modules, some of which may be specific to a particular operating system or platform.

The applications 316 include built-in applications 338 and/or third-party applications 340. Examples of representative built-in applications 338 may include, but are not limited to, a contacts application, a browser application, a book reader application, a location application, a media application, a messaging application, and/or a game application. The third-party applications 340 may include any application developed using the ANDROID™ or IOS™ software development kit (SDK) by an entity other than the vendor of the particular platform and may be mobile software running on a mobile operating system such as IOS™, ANDROID™, WINDOWS™ Phone, or other Mobile operating systems. The third-party applications 340 may invoke the API calls 308 provided by the mobile operating system (such as the operating system 302) to facilitate functionality described herein.

The applications 316 may use built-in operating system functions kernel 322, services 324, and/or drivers 326), libraries 320, and frameworks/middleware 318 to create user interfaces to interact with users of the system. Alternatively, or additionally, in sonic systems, interactions with a user may occur through a presentation layer, such as the presentation layer 314. In these systems, the application/component “logic” can be separated from the aspects of the application/component that interact with a user.

Some software architectures use virtual machines. In the example of FIG. 3, this is illustrated by a virtual machine 310. The virtual machine 310 creates a software environment where applications/components can execute as if they were executing on a hardware machine (such as the machine 400 of FIG. 4, for example). The virtual machine 310 is hosted by a host operating system (operating system 302 in FIG. 3) and typically, although not always, has a virtual machine monitor 360, which manages the operation of the virtual machine 310 as well as the interface with the host operating system operating system 302). A software architecture executes within the virtual machine 310, such as an operating system (OS) 336, libraries 334, frameworks 332, applications 330, and/or a presentation layer 328 These layers of software architecture executing within the virtual machine 310 can be the same as corresponding layers previously described or may be different.

FIG. 4 is a block diagram illustrating components of a machine 400, according to some example embodiments, able to read instructions from a machine-readable medium (e.g., a machine-readable storage medium) and perform any one or more of the methodologies discussed herein. Specifically, FIG. 4 shows a diagrammatic representation of the machine 400 in the example form of a computer system, within which instructions 410 (e.g., software, a program, an application, an applet, an app, or other executable code) for causing the machine 400 to perform any one or more of the methodologies discussed herein may be executed. As such, the instructions 410 may be used to implement modules or components described herein. The instructions 410 transform the general, non-programmed machine into a particular machine programmed to carry out the specific described and illustrated functions in the manner described.

In alternative embodiments, the machine 400 operates as a standalone device or may be coupled (e.g., networked) to other machines. To a networked deployment, the machine 400 may operate in the capacity of a server machine or a client machine in a server-client network environment, or as a peer machine in a peer-to-peer (or distributed) network environment. The machine 400 may comprise, but not be limited to, a server computer, a client computer, a personal computer (PC) a tablet computer, a laptop computer, a netbook, a set-top box (STB), a PDA, an entertainment media system, a cellular telephone, a smart phone, a mobile device, a wearable device (e.g., a smart-watch), a smart home device (e.g., a smart appliance), other smart devices, a web appliance, a network router, a network switch, a network bridge, or any machine capable of executing the instructions 410, sequentially or otherwise, that specify actions to be taken by the machine 400. Further, while only a single machine 400 is illustrated, the term “machine” shall also be taken to include a collection of machines that individually or jointly execute the instructions 410 to perform any one or more of the methodologies discussed herein.

The machine 400 may include processors 404, memory/storage 406, and I/O components 418, which may be configured to communicate with each other such as via a bus 402. The memory-/storage 406 may include a memory 414, such as a main memory, or other memory storage, and a storage unit 416. both accessible to the processors 404 such as via the bus 402. The storage unit 416 and memory 414 store the instructions 410 embodying any one or more of the methodologies or functions described herein. The instructions 410 may also reside, completely or partially, within the memory 414, within the storage unit 416, within at least one of the processors 404 (e.g., within the processor's cache memory), or any suitable combination thereof, during execution thereof by the machine 400. Accordingly, the memory 414, the storage unit 416, and the memory of the processors 404 are examples of machine-readable media.

The I/O components 418 may include a wide variety of components to receive input, provide output, produce output, transmit information, exchange information, capture measurements, and so on. The specific I/O components 418 that are included in a particular machine will depend on the type of machine. For example, portable machines such as mobile phones will likely include a touch input device or other such input mechanisms, while a headless server machine will likely not include such a touch input device. It will be appreciated that the I/O components 418 may include many other components that are not shown in FIG. 4. The I/O components 418 are grouped according to functionality merely for simplifying the following discussion and the grouping is in no way limiting. In various example embodiments, the I/O components 418 may include output components 426 and input components 428. The output components 426 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 428 may include alphanumeric input components a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g,., a microphone), and the like.

In further example embodiments, the I/O components 418 may include biometric components 430, motion components 434, environment components 436, or position components 438 among a wide array of other components. For example, the biometric components 430 may include components to detect expressions (e.g., hand expressions, facial expressions, vocal expressions, body gestures, or eye tracking), measure bio signals (e.g., blood pressure, heart rate, body temperature, perspiration, or brain waves), identify a person (e.g., voice identification, retinal identification, facial identification, fingerprint identification, or electroencephalogram-based identification), and the like. The motion components 434 may include acceleration sensor components (e.g., accelerometer), gravitation sensor components, rotation sensor components (e.g., gyroscope), and so forth. The environment components 436 may include, for example, illumination sensor components (e.g., photometer), temperature sensor components (e.g., one or more thermometers that detect ambient temperature humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 438 may include location sensor components (e.g., a Global Position System (GPS) receiver component, altitude sensor components (e.g., altimeters or barometers that detect air pressure from which altitude may be derived), orientation sensor components (e.g., magnetometers), and the like.

Communication may be implemented using a wide variety of technologies. The I/O components 418 may include communication components 440 operable to couple the machine 400 to a network 432 or devices 420 via a coupling 424 and a coupling 422 respectively, For example, the communication components 440 may include a network interface component or another suitable device to interface with the network 432. In further examples, the communication components 440 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 420 may be another machine or any of a wide variety of peripheral devices (e.g., a peripheral device coupled via a USB).

Moreover, the communication components 440 may detect or include components operable to detect identifiers. For example, the communication components 440 may include Radio Frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 440, such as location via Internet Protocol (IP) geolocation, location via Wi-Fi® signal triangulation, location via detecting an NFC beacon signal that may indicate a particular location, and so forth.

In this example, the systems and methods are described in the general context of computer program instructions executed by one or more computing devices that can take the form of a traditional server/desktop/laptop, mobile device such as a smartphone or tablet, etc. Computing devices typically include one or more processors coupled to data storage for computer program modules and data. Key technologies include, but are not limited to, the multi-industry standards of Microsoft and Linux/Unix based Operating Systems, databases such as SQL Server, Oracle, NOSQL, and DB2, Business Analytic/Intelligence tools such as SPSS, Cognos, SAS, etc., development tools such as Java, NET Framework (VB.NET, ASP.NET, AJAX.NET, etc.), and other e-commerce products, computer languages, and development tools. Such program modules generally include computer program instructions such as routines, programs, objects, components, etc., for execution by the one or more processors to perform particular tasks, utilize data, data structures, and/or implement particular abstract data types. While the systems, methods, and apparatus are described in the foregoing context, acts and operations described hereinafter may also be implemented in hardware.

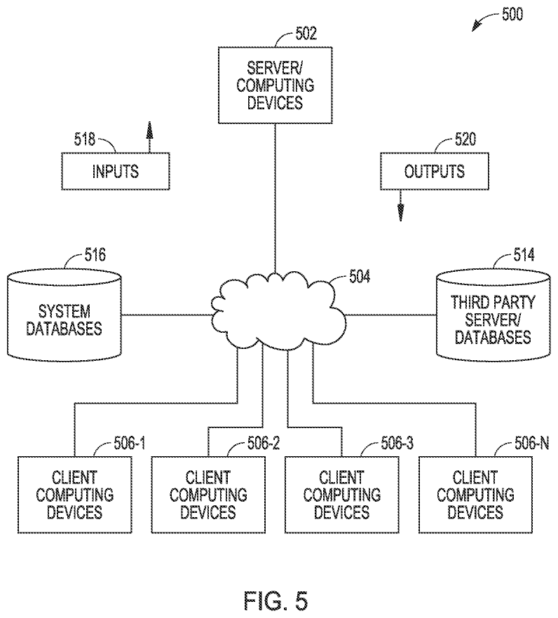

FIG. 5 shows a block diagram of another exemplary system 500 for management of targeted content curation and placement optimization according to one embodiment. In this exemplary implementation, the targeted content curation and placement optimization system 106 may include one or more servers/computing devices 502 (e.g., server 1, server 2, . . . , server n) operatively coupled over network 504 to one or more client computing devices 506-1 to 506-n, which may include one or more consumer computing devices, one or more provider computing devices, one or more remote access devices, etc. The one or more servers/computing devices 502 may also be operatively connected, such as over a network 504, to one or more third-party servers/databases 514 (e.g., database 1, database 2, . . . , database n). The one or more servers/computing devices 502 may also be operatively connected, such as over a network 504, to one or more system databases 516 (e.g., database 1, database 2, . . . , database n). Various devices may be connected to the system 500, including, but not limited to, client computing devices, consumer computing devices, provider computing devices, remote access devices, etc. The system 500 may receive inputs 518 and outputs 520 from the various computing devices, servers, and databases.

The server/computing device 502 may represent, for example, any one or more of a server, a general-purpose computing device such as a server, a personal computer (PC), a laptop, a smart phone, a tablet, and/or so on. Networks 504 represent, for example, any combination of the Internet, local area network(s) such as an intranet, wide area network(s), cellular networks, Wi-Fi networks, and/ or so on. Such networking environments are commonplace in offices, enterprise-wide computer networks, etc. Client computing devices 506, which may include at least one processor, represent a set of arbitrary computing devices executing application(s) that respectively send data inputs to server/computing device 502 and/or receive data outputs from server/computing device 502. Such computing devices include, for example, one or more of desktop computers, laptops, mobile computing devices (e.g., tablets, smart phones, human-wearable device), server computers, and/or so on. In this implementation, the input data comprises, for example, real-time campaign data, audience profile, attribution data, and/or so on, for processing with server/computing device 502. In one implementation, the data outputs include, for example, entails, templates, forms, and/or so on. Embodiments of the present disclosure may also be used for collaborative projects with multiple users logging in and performing various operations on a data project from various locations. Embodiments of the present disclosure may be web-based, smart phone-based and/or tablet-based or human-wearable device based.

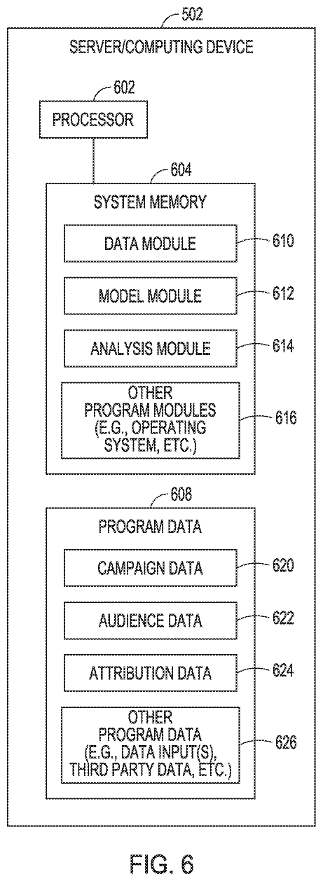

In this exemplary implementation, server/computing device 502 includes at least one processor 602. coupled to a system memory 604, as shown by the block diagram in FIG. 6. System memory 604 may include computer program modules 606 and program data 608. In this implementation, the program modules 606 may include data module 610, model module 612, analysis module 614, and other program modules 616 such as an operating system, device drivers, etc. Each module 610 through 616 may include a respective set of computer-program instructions executable by processor(s 602. This is one example of a set of program modules; other numbers and/or arrangements of program modules are contemplated as a function of the particular arbitrary design and/or architecture of server/computing device 502. and/or system 500 (FIG. 5). Additionally, although shown on a single server/computing device 502, the operations associated with respective computer-program instructions in the program modules 606 could be distributed across multiple computing devices. The program data 608 may include campaign data 620, audience data 622, attribution data 624, and other program data 626 such as data input(s), third-party data, and/or others,

As shown in FIG-. 7, in some examples, a survey or series of surveys are placed by a marketer or publisher at a specified location or domain in available inventory. The specified location or domain may be reserved for placement of a subsequent advertisement relating to the topic of interest, or survey responses. An online consumer (e.g., a user as described above) responds to the survey and makes selections relating to a topic of interest in a survey question. The consumer's response to the survey question may trigger an additional survey and present the subsequent survey to the end consumer. After a series of surveys and end consumer responses, a reserved or placed advertisement selects creative from a number of clients/marketers. In some examples, further numbers or types of surveys can be presented in the available inventory. Some examples may facilitate transactions between the marketer, the publisher, and the consumer pursuant to presentation of the survey or targeted content curated in response thereto. For example, multiple payment opportunities may be provided for the publisher or marketer, for example one opportunity for the placement of the survey and a further opportunity for the advertisement following the survey response.

Filling available inventory following one or many survey responses may be done in a subsequent bid/auction environment with the added information of a user's responses and engagement with the advertisement. For example, a content provider (e.g., a marketer) may successfully bid for a placement of a survey at a specified location or domain in available inventory. In response to the winning be the placement may be reserved for the content provider and a survey or other piece of actionable content from the content provider may be displayed at the reserved placement. The content curation and placement optimization system 106 may capture user interactions with the survey as impression data and survey responses as customer data. The bidding exchange may then initiate a subsequent auction for a placement of a second survey and or advertisement at the specified location or domain. The impression data, survey responses, and or enriched customer identities may be presented to the content providers in the demand side portal so that the bids submitted by each content provider may be informed by user interactions with the original survey and the captured survey responses. In response to a successful bid at the subsequent auction, a subsequent placement may be reserved for the winning content provider. A subsequent survey, advertisement, or other piece of targeted actionable content may be selected by the winning content provider based on the impression data, customer data, and or enriched customer identities. The selected piece of actionable content is then displayed at the reserved placement.

The process of displaying a survey or other piece of targeted content, capturing the impression data and customer data, initiating a subsequent auction, displaying the captured impression data, survey responses, and/or enriched customer identities to content providers, receiving bids for the placement of a subsequent piece of targeted content based on the impression data, customer data, and or enriched customer identities, reserving the placement for a winning content provider, selecting a subsequent piece of targeted actionable content based on the impression data, customer data, and or enriched customer identities, and displaying the subsequent piece of targeted actionable content at the reserved placement may repeat for each placement in a. series of placements reserved for advertising on a particular topic of interest at a specified location or domain in available inventory. The result is a more valuable advertising placement as the marketer is made aware that the user is engaged and of what the user's response(s) to the survey question(s) are.

Alternatively, the system 500 may automatically select/prioritize the marketer with the best match to the engagement. For example, the content curation and placement optimization system may determine a user presented with a survey related to consumer electronics is interested in purchasing high end headphones based on the impression data and customer data derived from the user's interactions with the survey. The content curation and placement optimization system 106 may then select marketers selling high end headphones and related products and services for a subsequent placement at the specified location or domain where the original survey was published by initiating a bidding process or sending a request to bid or other notification to the selected marketers in the demand side portal. In various embodiments, the content curation and placement optimization system 106 may programmatically reserve the subsequent placement for one or more marketers or select a subsequent survey, advertisement, or other piece of targeted content provided by one or more marketers based on the impression data and or customer data derived from the user interactions with the survey.

The content curation and placement optimization system 106 may process a transaction between the marketer or other content provider and the publisher for the placement of each survey and or advertisement in a series of placements. In various embodiments, the supply side portal by dynamically adjust the price for each placement based on the availability of impression data and or customer data for users that have navigated to a particular location or domain within a publication network. For example, reserving placements following a survey that has received a response from a user may be more expensive than reserving placements for an initial survey and or reserving placements following surveys that have not received a response.

In some examples, a publisher offers the available inventory after the survey with enriched data of the users' responses for more optimizing bidding. In some examples, scripts embedded in a winning placement for a survey independently handle multi-party bidding with the enriched data, In some examples, one or more surveys placed in available inventory communicate with a response-server to fill the available inventory based on the customer identity resolution in the data cloud in conjunction with the user responses against pre-bid priorities of multiple marketers. For example, the content curation and placement optimization system may enrich customer identities stored in an identity graph, data cloud, or other database by identifying an individual customer identity in the identity graph that corresponds to a user presented with a survey and adding the impression data and customer data to the customer identity. The enriched customer identities may be provided to marketers in the demand side portal so that marketers may bid for subsequent placements at the specified location or domain based on the enriched customer identities. The content curation and placement optimization system may also programmatically fill available inventory at the specified location or domain based on a comparison of the enriched customer identities and pre-bid priorities of one or more marketers. For example, the content curation and placement optimization system may select a marketer and or a piece of targeted content provided by the marketer for a placement at the specified location or domain based on an enriched customer identity of a user indicating the user is a male over 30 interested in purchasing tax advice and the pre-bid priorities of the selected marketer indicating they wish to target males over 30 that are interested in purchasing tax advice.

Thus, in some examples, a content curation and placement optimization system 106 or 500 comprises a processor, such as the content curation and placement optimization Components 206, connected to a publication network, such as the publication network 208 or 504. The publication network is navigated by an online consumer seeking actionable content. The content curation and placement optimization system includes an online demand side portal accessible, via the publication network, to a content provider, and an online supply side portal accessible, via the network, to a publisher of content on the publication network. An integrated bidding exchange is communicatively coupled to the demand side portal and the supply side portal, the bidding exchange presenting user interfaces enabling receipt of bids from the content provider for placement of content by the publisher at a specified location or domain on the publication network.

The processor is configured to reserve, upon receipt of a successful bid from the content provider, the specified location or domain for placement of targeted content to the consumer. In some examples, the processor is further configured to present a user interface, to the consumer, at the reserved specified location or domain, a survey soliciting feedback from the consumer on a content topic of interest to be presented to the consumer at the specified location or domain on the publication network.

In some examples, the processor is further configured to receive consumer responses to the survey and select or curate, based on the survey responses, targeted content to be presented to the consumer at the specified location or domain on the publication network. In some examples, the processor is further configured to present the targeted content to the consumer at the specified location or domain on the publication network. In some examples, the processor is further configured to process a transaction between the content provider and the publisher based on the presentation or a viewing of the targeted content by the consumer.

In some examples, the processor is further configured to process a transaction between the content provider and the publisher based on the presentation or a viewing of the targeted content by the consumer or a third party. In some examples, the targeted content is first targeted content selected or curated for a first consumer, and the processor is further configured to present a second user interface, to a second consumer, at the reserved specified location or domain, a survey soliciting feedback from the second consumer on a second content topic of interest to be presented to the second consumer at the specified location or domain,

In some examples, the processor is further configured to receive second consumer feedback and select or curate, based on survey responses, second targeted content to be presented to the second consumer at the specified location or domain. In some examples, the processor is further configured to detect a presence of the second consumer at the specified location or domain and present the second targeted content to the second consumer at the specified location or domain. In some examples, the processor is further configured to process a second transaction between the content provider and the publisher based on the presentation or a viewing of the second targeted content by the second consumer.

In some examples, the processed transaction is based on one or both of the presentation of the survey or the presentation of the targeted content at the specified location or domain on the publication network. In some examples, the processed second transaction is based on one or both of the presentation of the second survey or the presentation of the second targeted content at the specified location or domain on the publication network. In some examples, the processor is further configured to adapt questions in the survey dynamically based on consumer responses to the survey and reselect or re-curate the targeted content based on responses to a dynamically adapted survey. In some examples, the processor is further configured to resolve or refine a consumer identity based on responses to the survey or an updated survey.

In further aspects as shown in FIG-S. 7-10, a consumer that has navigated to a location or domain in a publication network may, by virtue of answering a series of survey questions 702, select topics or aspects of interest as shown, and in doing so identify, for example, a marketer (e.g., a goods or service provider such as a tax consultant) to see advertisement from in the available inventory. In some embodiments, the consumer may select from a number of available advertisers or type in a company to engage with. Some examples allow the consumer to select from a type of advertisement, for example a type that includes a discount, or an efficiency, or an ease of use, or other points of interests. In some examples, the consumer's responses are used to select or create targeted content from the identified marketer to appear at the location or domain in the inventory.

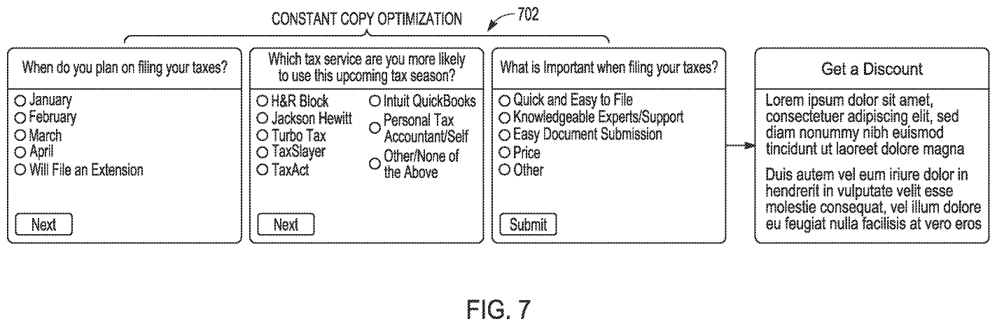

As shown for example in FIG. 7, the consumer's responses may lead to the presentation of targeted and relevant search results or content. In this example, a consumer may view an available inventory space that has been populated with a survey. The survey may ask when the consumer plans to file their taxes. If the consumer makes a date selection, that month is recorded in a database, such as the data cloud, and stored in association with an identifier of the consumer. The response indicates in the system that the user is engaged and may capture metrics of the consumer which can be used or be insightful in other marketing opportunities.

In some examples, the targeted content curation and placement optimization system 106 or 500 identifies that the consumer is engaged and has made a selection in a first part of the survey. The consumer is presented with additional survey questions and invited to engage further. In the embodiment shown in FIG, 7, the consumer is asked to select from a plurality of tax preparation providers. After a series of survey responses, the system determines what to show the end consumer. In the embodiment illustrated in FIG. 7, the system populates the available inventory with search results that are relevant to the consumer based on the consumer's engagement responses.

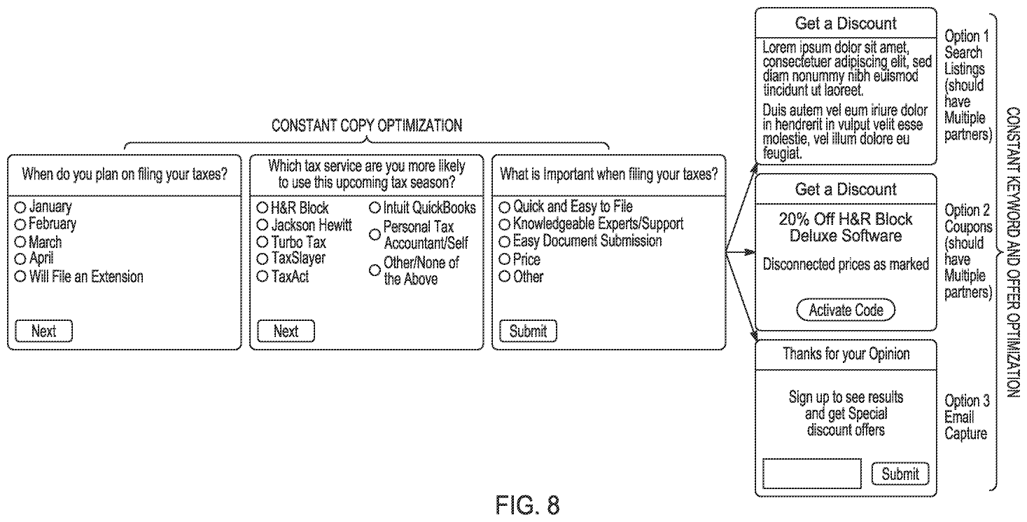

In other embodiments, as illustrated in FIG. 8, the targeted content curation and placement optimization system 106 or 500 selects from a number of options to present in the available inventory at the conclusion of the survey. In some examples, the system 106 can make targeted content presentation decisions along the path of the survey, or at defined times during the survey, or at the end of a predetermined set of questions or number of questions.

In some examples, while three options for the presentation of targeted content (in this example, the illustrated advertisements) are presented in FIG. 8, the targeted content curation and placement optimization system 106 or 500 may select from any number of available content or advertisements. Further, the system 106 or 500 may generate content for the available inventory using information about the consumer and the consumer's responses. For example, the content curation and placement optimization system 106 may generate a piece of targeted content to display to the consumer at a domain the consumer navigates to based on impression data, customer data, and or an enriched customer identity derived from the consumer's engagement with the of the targeted content.

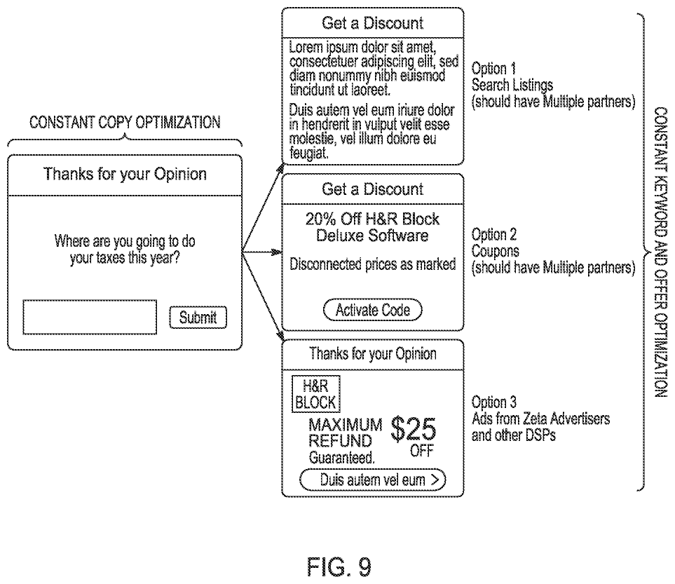

In further examples, the survey serves as a content capture for further consumer identity resolution and to better connect the consumer with the identified or recommended marketer. For example, in FIG. 9, a consumer is presented with a survey presenting a form in which to enter response information in exchange for a discount to be presented at some point during the survey process. In the example in FIG. 9, the available inventory is populated with a survey question asking where the consumer will file their taxes. When the consumer enters a tax preparer, the system can select advertisements from the entered tax preparer to better connect the consumer with the provider. The result is a better value placement for the marketer, and more concise information (targeted content) for the consumer. The marketer is made aware and reassured it is reaching a consumer who is potentially interested in using its service.

In some examples, capture of survey responses or consumer information may relate to a particular survey or additional consumer information, such as demographic or contact information. For example, the survey may ask for a consumer's email address in order to receive a coupon for a relevant service and use the contact information to better understand the consumer or to match the login information without cookies to add additional identity resolution. For example, the email address or other identifier captured in the survey response may be matched with an individual customer identity in an identity graph, data cloud, or other database. The consumer interacting with the survey may be associated with the matched individual customer identity without cookies or other software for tracking the consumer. Once the customer identity that corresponds to the consumer is determined, the impression data. and customer data derived from the consumer's engagement with the survey may be added to the relevant customer identity along with other impressions, clicks, transactions, and other browsing activities of the consumer at the domain in order to enhance the understanding of the consumer. Other combinations of survey questions are possible. For example, while FIG. 9 shows the response request being presented as an initial survey question, it may appear in some examples at other times in a series of survey questions.

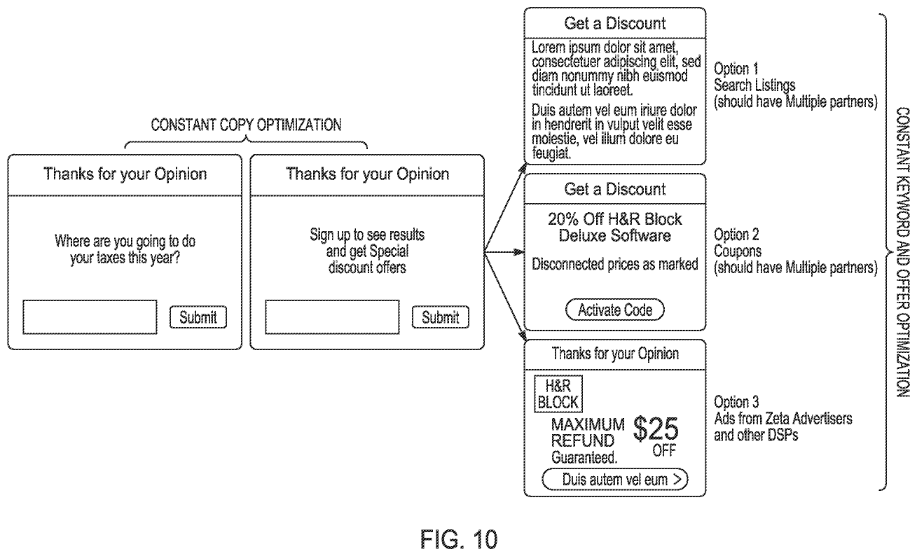

As shown in FIG. 10, the survey may include multiple rounds of consumer captures in order both to collect information and optimize the best advertisement (targeted content) to present in the available inventory. In some examples, a survey may present other numbers or orders of survey question types including forced choice and open-ended capture questions.

In some embodiments, the targeted content curation and placement optimization system 106 or 500 dynamically adjusts or adapts the survey based on consumer responses from each round and adapts the content of a webpage, for example, hosted at a given location or domain in the available inventory.

In some examples, the targeted content curation and placement optimization system 106 or 500 stores a consumer's survey responses in association with a consumer identifier in a database. In some examples, consumer survey responses may include personal details such as an email address or other contact information, demographic details, interest details, opinion details, or any other survey response. As used herein, a database may be a relational database, flat file database, relational database management system, object database management system, operational database, data warehouse, hyper media database, post-relational database, hybrid database models, RDF database, key value database, XML database, XML store, text file, flat file, or other type of database.

In various examples, the targeted content curation and placement optimization system 106 or 500 collects information and transactions tied to user identifiers including third-party cookies, single sign on. IP addresses, or any other means of identifying an individual end consumer and can detect patterns of transaction events. In some embodiments, the desired transaction events include a purchase, a sign-up, a click-through for a particular client, or the like.

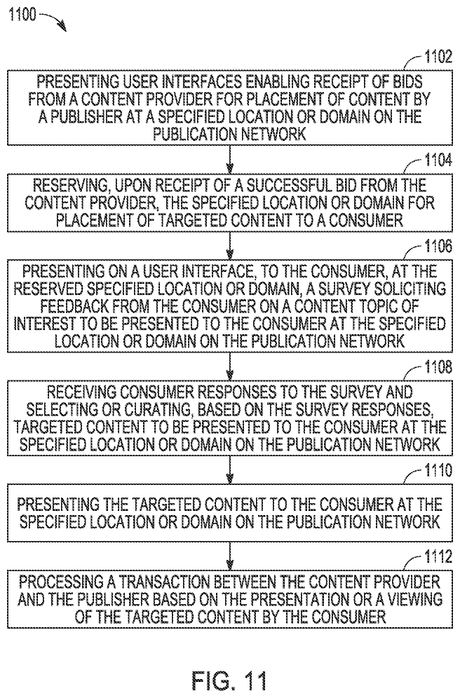

Some present examples also include methods. FIG. 11 is a flow diagram illustrating example operations in an example method 1100 of curating and placing targeted content in a publication network, the method 1100 comprising: at operation 1102, presenting user interfaces enabling receipt of bids from a content provider for placement of content by a publisher at a specified location or domain on the publication network; at operation 1104, reserving, upon receipt of a successful bid from the content provider, the specified location or domain for placement of targeted content to a consumer; at operation 1106, presenting on a user interface, to the consumer, at the reserved specified location or domain, a survey soliciting feedback from the consumer on a content topic of interest to be presented to the consumer at the specified location or domain on the publication network; at operation 1108, receiving consumer responses to the survey and selecting or curating, based on the survey responses, targeted content to be presented to the consumer at the specified location or domain on the publication network; at operations 1110, presenting the targeted content to the consumer at the specified location or domain on the publication network; and at operation 1112, processing a transaction between the content provider and the publisher based on the presentation or a viewing of the targeted content by the consumer.

In some examples, the method 1100 further comprises processing a. transaction between the content provider and the publisher based on the presentation or a viewing of the targeted content by the consumer or a third party.

In some examples, the targeted content is a first content selected or curated for a first consumer, and wherein the method 1100 further comprises presenting on a second user interface, to a second consumer, at the reserved specified location or domain, a survey soliciting feedback from the second consumer on a second content topic of interest to be presented to the second consumer at the specified location or domain; receiving second consumer feedback and selecting or curating, based on survey responses, second targeted content to be presented to the second consumer at the specified location or domain; detecting a presence of the second consumer at the specified location or domain and presenting the second targeted content to the second consumer at the specified location or domain; and processing a second transaction between the content provider and the publisher based on the presentation or a viewing of the second targeted content by the second consumer.

In sone examples, the processed transaction is based on one or both of the presentation of the survey or the presentation of the targeted content at the specified location or domain on the publication network.

In some examples, the processed second transaction is based on one or both of the presentation of the second survey or the presentation of the second targeted content at the specified location or domain on the publication network.

In some examples, the method 1100 further comprises adapting questions in the survey dynamically based on consumer responses to the survey and reselecting or re-curating the targeted content based on responses to a dynamically adapted survey.

In some examples, the method 1100 further comprises resolving or refining a consumer identity based on responses to the survey or an updated survey.

In some examples, a non-transitory machine-readable medium includes instructions which, when read by a machine, cause the machine to perform operations in a method of curating and placing targeted content in a publication network, the operations comprising any one or more of the operations summarized above or described elsewhere herein.

Although the subject matter has been described with reference to specific example embodiments, it will be evident that various modifications and changes may be made to these embodiments without departing from the broader spirit and scope of the disclosed subject matter. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Description, therefore, is not to be taken in a limiting sense, and the scope of various embodiments is defined only by any appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A targeted content curation and placement optimization system comprising:
a processor connected to a publication network, the publication network navigated by an online consumer seeking actionable content;
an online demand side portal accessible, via the publication network, to a content provider;
an online supply side portal accessible, via the publication network, to a publisher of content on the publication network;
an integrated bidding exchange communicatively coupled to the online demand side portal and the online supply side portal, the bidding exchange presenting user interfaces enabling receipt of bids from the content provider for placement of content by the publisher at a specified location or domain on the publication network;
the processor configured to reserve, upon receipt of a successful bid from the content provider, the specified location or domain for placement of targeted content to the online consumer;
the processor further configured to present on a user interface, to the online consumer, at the reserved specified location or domain, a survey soliciting feedback from the online consumer on a content topic of interest to be presented to the online consumer at the specified location or domain on the publication network;
the processor further configured to receive consumer responses to the survey and select or curate, based on the survey responses, targeted content to be presented to the consumer at the specified location or domain on the publication network;
the processor further configured to present the targeted content to the online consumer at the specified location or domain on the publication network; and
the processor further configured to process a transaction between the content provider and the publisher based on the presentation or a viewing of the targeted content by the consumer.

2. The targeted content curation and placement system of claim 1, wherein the processor is further configured to process a transaction between the content provider and the publisher based on the presentation or a viewing of the targeted content by the consumer or a third party.

3. The targeted content curation and placement system of claim 1, wherein the targeted content is a first targeted content selected or curated for a first consumer, and wherein the processor is further configured to:
present on a second user interface, to a second consumer, at the reserved. specified location or domain, a survey soliciting feedback from the second consumer on a second content topic of interest to be presented to the second consumer at the specified location or domain;
the processor further configured to receive second consumer feedback and select or curate, based on survey responses, second targeted content to be presented to the second consumer at the specified location or domain;
the processor further configured to detect a presence of the second consumer at the specified location or domain and present the second targeted content to the second consumer at the specified location or domain; and
the processor further configured to process a second transaction between the content provider and the publisher based on the presentation or a viewing of the second targeted content by the second consumer.

4. The targeted content curation and placement system of claim 1. wherein the processed transaction is based on one or both of the presentation of the survey or the presentation of the targeted content at the specified location or domain on the publication network,

5. The targeted content curation and placement system of claim 3, wherein the processed second transaction is based on one or both of the presentation of the second survey or the presentation of the second targeted content at the specified location or domain on the publication network.

6. The targeted content curation and placement system of claim 1, wherein the processor is further configured to adapt questions in the survey dynamically based on consumer responses to the survey and reselect or re-curate the targeted content based on responses to a dynamically adapted survey.

7. The targeted content curation and placement system of claim 6, wherein the processor is further configured to resolve or refine a consumer identity based on responses to the survey or an updated survey.

8. A method of curating and placing targeted content in a publication network, the method comprising:
presenting user interfaces enabling receipt of bids from a content provider for placement of content by a publisher at a specified location or domain on the publication network;
reserving, upon receipt of a successful bid from the content provider, the specified location or domain for placement of targeted content to a consumer;
presenting on a user interface, to the consumer, at the reserved specified location or domain, a survey soliciting feedback from the consumer on a content topic of interest to be presented to the consumer at the specified location or domain on the publication network;
receiving consumer responses to the survey and selecting or curating, based on the survey responses, targeted content to be presented to the consumer at the specified location or domain on the publication network;
presenting the targeted content to the consumer at the specified location or domain on the publication network; and
processing a transaction between the content provider and the publisher based on the presentation or a viewing of the targeted content by the consumer.

9. The method of claim 8, further comprising processing a transaction between the content provider and the publisher based on the presentation or a viewing of the targeted content by the consumer or a third party.

10. The method of claim 8, wherein the targeted content is a first content selected or curated for a first consumer, and wherein the method further comprises:
presenting on a second user interface, to a second consumer, at the reserved. specified location or domain, a survey soliciting feedback from the second consumer on a second content topic of interest to be presented to the second consumer at the specified location or domain;
receiving second consumer feedback and selecting or curating, based on survey responses, second targeted content to be presented to the second consumer at the specified location or domain;
detecting a presence of the second consumer at the specified location or domain and presenting the second targeted content to the second consumer at the specified location or domain; and
processing a second transaction between the content provider and the publisher based on the presentation or a viewing of the second targeted content by the second consumer.

11. The method of claim 8, wherein the processed transaction is based on one or both of the presentation of the survey or the presentation of the targeted content at the specified location or domain on the publication network.

12. The method of claim 10, wherein the processed second transaction is based on one or both of the presentation of the second survey or the presentation of the second targeted content at the specified location or domain on the publication network.

13. The method of claim 8, further comprising adapting questions in the survey dynamically based on consumer responses to the survey and reselecting or re-curating the targeted content based on responses to a dynamically adapted survey.

14. The method of claim 13, further comprising resolving or refining a consumer identity based on responses to the survey or an updated survey.

15. A non-transitory machine-readable medium including instructions which, when read by a machine, cause the machine to perform operations in a method of curating and placing targeted content in a publication network, the operations comprising:
presenting user interfaces enabling receipt of bids from a content provider for placement of content by a publisher at a specified location or domain on the publication network;
reserving, upon receipt of a successful bid from the content provider, the specified location or domain for placement of targeted content to a consumer;
presenting on a user interface, to the consumer, at the reserved specified location or domain, a survey soliciting feedback from the consumer on a content topic of interest to be presented to the consumer at the specified location or domain on the publication network;
receiving consumer responses to the survey and selecting or curating, based on the survey responses, targeted content to be presented to the consumer at the specified location or domain on the publication network;
presenting the targeted content to the consumer at the specified location or domain on the publication network; and
processing a transaction between the content provider and the publisher based on the presentation or a viewing of the targeted content by the consumer.

16. The medium of claim 15, wherein the operations further comprise processing a transaction between the content provider and the publisher based on the presentation or a viewing of the targeted content by the consumer or a third party.

17. The medium of claim 15, wherein the targeted content is a first content selected or (waled for a first consumer, and wherein the operations further comprise:
presenting on a second user interface, to a second consumer, at the reserved specified location or domain, a survey soliciting feedback from the second consumer on a second content topic of interest to be presented to the second consumer at the specified location or domain;
receiving second consumer feedback and selecting or curating, based on survey responses, second targeted content to be presented to the second consumer at the specified location or domain;
detecting a presence of the second consumer at the specified location or domain and presenting the second targeted content to the second consumer at the specified location or domain; and
processing a second transaction between the content provider and the publisher based on the presentation or a viewing of the second targeted content by the second consumer.

18. The medium of claim 15, wherein the processed transaction is based on one or both of the presentation of the survey or the presentation of the targeted content at the specified location or domain on the publication network.

19. The medium of claim 17, wherein the processed second transaction is based on one or both of the presentation of the second survey or the presentation of the second targeted content at the specified location or domain on the publication network.

20. The medium of claim 15, wherein the operations further comprise adapting questions in the survey dynamically based on consumer responses to the survey and reselecting or re-curating the targeted content based on responses to a dynamically adapted survey.
